(19) United States
(12) Patent Application Publication
(10) Pub. No.: US 2026/0341255 A1
(43) Pub. Date: Oct. 29, 2026

(54) Circular keyboard musical instrument with determinate-pitch tones of indeterminate octave

(71) Applicant: Laurence Jay Shaw, San Rafael, CA (US)

(72) Inventor: Laurence Jay Shaw, San Rafael, CA (US)

(21) Appl. No.: 19/660,237

(22) Filed: Apr. 28, 2026

Related U.S. Application Data
(60) Provisional application No. 63/796,372, filed on Apr. 29, 2025.

(51) Int. Cl. G10H 1/34; G10H 1/00; G10H 1/14

(52) U.S. Cl. CPC G10H 1/34; G10H 1/0008; G10H 1/14; G10H 2210/325; G10H 2220/026; G10H 2220/221; G10H 2220/265; G10H 2250/025

(57) ABSTRACT

A musical instrument with a circular keyboard providing a twelve-note Western chromatic scale of ring pitches—“ring pitches” being defined as tones having identifiable pitches but being of indeterminant octave—so that depression of any key followed by depression of the next key counter-clockwise is perceived as playing notes ascending in pitch, and depression of any key followed by depression of the next key clockwise is perceived as playing notes descending in pitch. (This is the audio equivalent of the continually ascending/descending Escher staircase.) Ring pitch D, for instance, is created by adding together instrument tones of pitch d from multiple octaves according to an amplitude envelope which has a width at half maximum which spans a plurality of octaves. Black note keys of the circular keyboard are wider than and extend higher than white note keys, highlighting pentatonic scales and facilitating their play by small children with the palms of the hands. In one embodiment, the black note keys are higher than the white note keys at the circumference of the toy, and the white note keys are higher than the black note keys near the center of the toy. The key mechanisms may have velocity of force sensing with higher velocity or more forceful strikes making the transients of the tones more percussive and/or causing the sustain portions of the tones to include more overtones, but not altering volume. The keys may be illuminated corresponding to ring pitch filtering of current ambient sound to reflect the current chord of ambient music, thereby facilitating the ability to play along with the ambient music.

### FIELD OF THE INVENTION

The present invention relates to musical instruments and children's toys.

### BACKGROUND OF THE INVENTION

Playing musical instruments is fun, rewarding, and beneficial to mental health and emotional well-being. Furthermore, it is well-known that playing musical instruments is particularly beneficial to the development of children, assisting in the development of coordination, math skills, pattern recognition, memory, imagination, creativity, etc.

Many different types of musical instruments have been developed over the course of human civilization. In more recent history this includes the development of a variety of electronic instruments. A number of musical instruments are marketed that are designed particularly for children, such as small xylophones, single octave, octave-and-a-half and two octave pianos, small guitars and other types of small stringed instruments, etc. Sadly, children's instruments are generally of poor quality, poorly tuned or not readily tunable, and often have small keyboards which make them difficult for very young children to play. Therefore, young children are deprived of the opportunity to play music simply because suitable instruments are not available.

While a few Western instruments only allow the playing of notes within a particular scale (such as the harmonica or concertina which allow for the play of notes of the major scale), most Western instruments are chromatic, i.e., they include the pitches associated with both the white keys (c, d, e, f, g, a and b) and black keys (c #/d@, d #/e@, f #/g@, g #/a@, and a #/b@) of the piano, and any scale can be played on them. However, for young children it is beneficial to use instruments having a limited number of keys. Some children's pianos and xylophones have a keyboard which only spans an octave. On a piano keyboard covering only an octave, which is generally the octave from a c such as middle c to the c an octave above, the five black keys are c #, d #, f #, g #and a #. In Western music, the major pentatonic scale is generally considered one of the easiest and most accessible scales for beginners to play and improvise on. However, the tonic of the major pentatonic scale is an f#, and therefore the pentatonic scale from f #to the f #an octave above (i.e., f #, g #, a #, c #, d #and f #in order of increasing pitch) cannot be played on the black keys of a standard one-octave children's piano or xylophone.

A Western instrument which has a circular layout is the steel pan, also known as the steel drum. A steel pan is made from a dome of steel into which sound plates are formed by embossing to physically isolate circular plates. The larger, outside plates are typically arranged in two concentric circles, and within the central region there are commonly four additional plates. Somewhat counter-intuitively, especially for small children, adjacent plates within each circle differ by a major fourth or a major fifth in pitch, i.e., the notes are arranged in what is known as the circle of fifths.

It is therefore an object of the present invention to provide a musical instrument which can readily be played by young children.

It is further an object of the present invention to provide a musical instrument which provides a chromatic scale but particularly facilitates play of a pentatonic scale.

It is further an object of the present invention to provide a musical instrument which allows children to play tones, and in particular a pentatonic scale, with impacts of their palms.

It is further an object of the present invention to provide a musical instrument which allows multiple children to readily improvise together on one or multiple instruments.

It is another object of the present invention to provide a musical instrument with a circular keyboard.

It is another object of the present invention to provide a musical instrument with a circular keyboard which produces tones of indeterminate octave but determinate pitch.

Furthermore, it is an object of the present invention to provide a musical instrument with a circular keyboard where between every pair of adjacent key the more counter-clockwise key is perceived as having the higher pitch than the more clockwise key.

Alternatively, it is an object of the present invention to provide a musical instrument with a circular keyboard where between every pair of adjacent keys the more counter-clockwise key is perceived as having the lower pitch than the more clockwise key.

It is another object of the present invention to provide a musical instrument which has a limited number of keys yet can play melodies involving any scale.

It is another object of the present invention to provide a musical instrument which has a chromatic octave of keys yet can play melodies involving any scale.

It is another object of the present invention to provide a musical instrument for young children that helps develop musical understanding and intuition of the pentatonic scales.

It is another object of the present invention to provide a musical instrument with a keyboard which provides a chromatic scale, yet highlights a pentatonic scale.

More particularly, it is an object of the present invention to provide a musical instrument with a keyboard which provides a full octave chromatic scale, and highlights a pentatonic scale.

Still more particularly, it is an object of the present invention to provide a musical instrument with a keyboard which provides a full octave chromatic scale, and highlights the major pentatonic scale and the major scale.

Furthermore, it is an object of the present invention to provide a musical instrument where the black notes (i.e., the major pentatonic scale) can be played by a young child with the palms of the hand, while the white notes (i.e., a major scale) requires more motor control such as use of the fingers.

More particularly, it is an object of the present invention to provide a musical instrument where the black keys (i.e., the major pentatonic scale) are large and have elevated surfaces so they can be played by a young child with the palms of the hand, while the white keys (i.e., the major scale) are smaller and recessed and so it is required that the child utilize the fingers to play them.

Additional objects and advantages of the invention will be set forth in the description which follows, and will be obvious from the description or may be learned by practice of the invention. The objects and advantages of the invention may be realized and obtained by means of the instrumentalities and combinations particularly pointed out in the claims of the nonprovisional application which will be based on the present provisional application.

### BRIEF DESCRIPTION OF THE DRAWINGS

The accompanying figures, which are incorporated in and form a part of this specification, illustrate embodiments of the invention and, together with the description given above and the detailed description of the preferred embodiments given below, serve to explain the principles of the invention.

FIG. 1A shows a top plan view of a circular keyboard instrument according to the present invention where the keys have straight edges.

FIG. 1B shows a perspective view of the circular keyboard instrument according to an alternate embodiment the present invention where the keys have rounded edges

FIG. 2 shows the frequency spectrum of tones according to the present invention for a central tone and two tones related to the central tone by a half step up and a half step down.

### DETAILED DESCRIPTION OF THE PRESENT INVENTION

The piano is one of the most ergonomic of instruments and there is a profound beauty to the layout of the white and black keys. The keyboard of the present invention utilizes the mapping between pitches and black and white key utilized by the piano, but is circular and highlights the black keys. Furthermore, the tones produced by the circular keyboard of the present invention have a frequency spectrum which allows a continuous sequence of steps in the counter-clockwise direction to sound as if the pitch is continually increasing, and a continuous sequence of steps in the clockwise direction to sound as if the pitch is continually increasing. I.e., the tones of the keyboard of the present invention are pitch determinate but octave indeterminate.

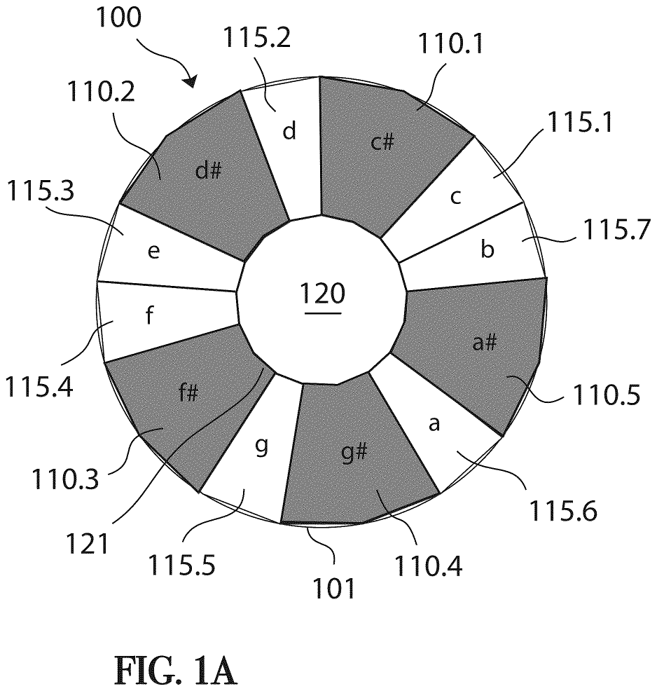

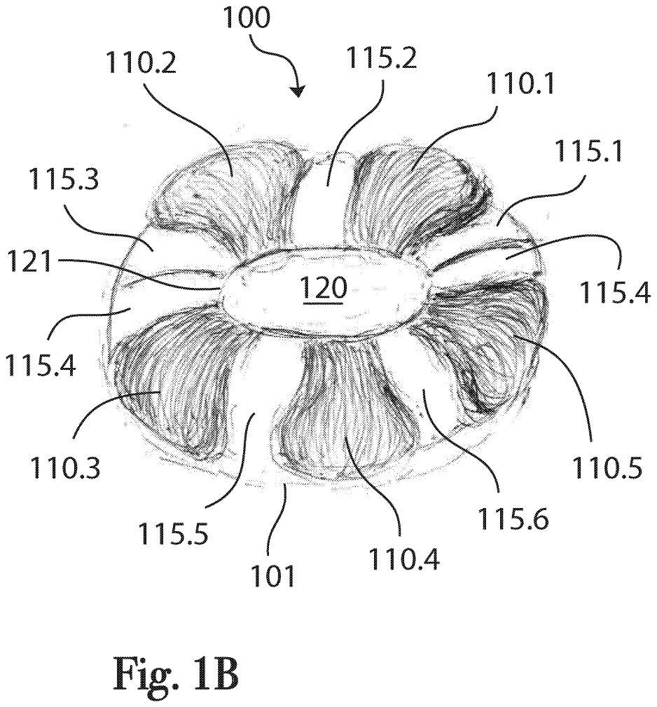

FIG. 1A shows a top plan view of a first embodiment and FIG. 1B shows a perspective view of a second embodiment of the circular keyboard (100) of the present invention. (Although FIGS. 1A and 1B show embodiments having differently shaped keys, the same reference numerals are utilized in both figures.) The circular keyboard (100) has twelve keys, five of the keys (110.1), (110.2), (110.3), (110.4) and (110.5) have tones corresponding to the black keys of a piano (i.e., the notes c #, d #, f #, g #, and a #, respectively), and seven of the keys (115.1), (115.2), (115.3), (115.4), (115.5), (115.6) and (115.7) have tones corresponding to the white keys of the piano (i.e., the notes c, d, e, f, g, a and b, respectively).

The black keys will be referred to herein collectively or generically with reference numeral “110” and the white keys will be referred to herein collectively or generically with reference numeral “115”. Although referred to as the “black” and “white” keys in the present specification, this is not intended to indicate a limitation in color. The “black” keys (110) may be any color and the “white” keys (115) may be any color on the circular keyboard (100) of the present invention.

The circular keyboard (100) is roughly 28 cm in diameter, and the central speaker (120) has a diameter of roughly 9 cm. As can be seen in the embodiments of both FIG. 1A and FIG. 1B, the black keys (110) are considerably larger than the white keys (115). In the embodiment shown in FIG. 1A, at the outer circumference (101) of the circular keyboard (100) each of the five black keys (110) has a width of roughly 2/17^{th} the circumference of the circular keyboard (100), and each of the seven white keys (115) has a width which is roughly 1/17^{th} the circumference of the circular keyboard (100). Similarly, where the black keys (110) and white keys (115) abut the speaker (120), each of the five black keys (110) has a width of roughly 2/17^{th} of the circumference (121) of the speaker (120), and each of the seven white keys (115) has a width of roughly 1/17^{th} of the circumference (121) of the speaker (120). According to the present invention, the plan-view area of each black key (110) is 2/17^{ths}±20% of the plan-view area of the keyboard (100), more particularly the plan-view area of each black key (110) is 2/17^{ths}±15% of the plan-view area of the keyboard (100), more particularly the plan-view area of each black key (110) is 2/17^{ths}±10% of the plan-view area of the keyboard (100), and still more particularly the plan-view area of each black key (110) is 2/17^{ths}±5% of the plan-view area of the keyboard (100). Similarly, according to the present invention, the plan-view area of each white key (115) is 1/17^{th}±20% of the plan-view area of the keyboard (100), more particularly the plan-view area of each white key (115) is 1/17^{th}±15% of the plan-view area of the keyboard (100), more particularly the plan-view area of each white key (115) is 1/17^{th}±10% of the plan-view area of the keyboard (100), and still more particularly the plan-view area of each white key (115) is 1/17^{th}±5% of the plan-view area of the keyboard (100). According to an alternate embodiment of the present invention, at the outer circumference (101) of the circular keyboard (100) each of the five black keys (110) has a width of roughly 3/29^{ths} the circumference of the circular keyboard (100), and each of the seven white keys (115) has a width which is roughly 2/29^{ths} the circumference of the circular keyboard (100), and similar ratios hold where the black keys (110) and white keys (115) abut the speaker (120). According to this embodiment present invention, the plan-view area of each black key (110) is 3/29^{ths}±20% of the plan-view area of the keyboard (100), more particularly the plan-view area of each black key (110) is 3/29^{ths}±15% of the plan-view area of the keyboard (100), more particularly the plan-view area of each black key (110) is 3/29^{ths}±10% of the plan-view area of the keyboard (100), and still more particularly the plan-view area of each black key (110) is 3/29^{ths}±5% of the plan-view area of the keyboard (100). Similarly, according to this embodiment of the present invention, the plan-view area of each white key (115) is 2/29^{ths}±20% of the plan-view area of the keyboard (100), more particularly the plan-view area of each white key (115) is 2/29^{ths}±15% of the plan-view area of the keyboard (100), more particularly the plan-view area of each white key (115) is 2/29^{ths}±10% of the plan-view area of the keyboard (100), and still more particularly the plan-view area of each white key (115) is 2/29^{ths}±5% of the plan-view area of the keyboard (100).

According to another embodiment of the present invention, the plan-view area of each black key (110) and white key (115) is 1/12^{th}±20% of the plan-view area of the keyboard (100), more particularly 1/12^{th}±15% of the plan-view area of the keyboard (100), more particularly 1/12^{th}±10% of the plan-view area of the keyboard (100), and more particularly 1/12^{th}±5% of the plan-view area of the keyboard (100).

In the embodiment shown in FIG. 1B, the black keys (110) are larger than the black keys (110) in the embodiment shown in FIG. 1A and have curved perimeters. This makes the black keys (110) of the embodiment of FIG. 1B even easier for small children to strike, thereby further facilitating play of pentatonic scales (such as the major pentatonic scale, which is the notes f #, g #, a #, c #and d #). In particular, at the outer circumference (101) of the circular keyboard (100) the each of the five black keys (110) has a width of roughly 3/22^{nds} of the circumference of the circular keyboard (100), and each of the seven white keys (115) has a width which is roughly 1/22^{nd} of the circumference of the circular keyboard (100). Where the black and white keys (110) and (115) abut the speaker (120), each of the five black keys (110) has a width of roughly 2/17^{th} of the circumference (121) of the speaker (120), and each of the seven white keys (115) has a width of roughly 1/17^{th} of the circumference (121) of the speaker (120). The curved perimeters and the cardinality of two adjacent black keys (110.1) and (110.2) grouped together in the farther region and three adjacent black keys (110.3), (110.4) and (110.5) grouped together in the nearer region of the depiction of the embodiment shown in FIG. 1B gives this embodiment a flower-like resemblance since two and three are early numbers of the Fibonacci sequence.

While the paragraphs above state that the white keys (115) of each the pairs of adjacent white keys (i.e., the e and f (115.3) and (115.4), and the b and c (115.7) and (115.1)) have the same size and shape as the solo white keys between pairs of black keys (110) (i.e., the d, g and a (115.2), (115.5) and (115.6)), according to the present invention this is not strictly necessary. What is important however is that all the white keys (115) appear to be of roughly the same size and shape so as to appear to have the same musical role and be of equivalent musical importance. Broadly, what is important according to a preferred embodiment of the present invention is that the black keys (110) have more width than the white keys (115), the black keys (110) appear to be of roughly the same size and shape, and the white keys (115) appear to be of roughly the same size and shape.

As can be seen from FIB. 1B, the top surfaces of the black keys (110) are somewhat elevated with respect to the white keys (115) and the top surfaces are arched, while the top surfaces of the white keys (115) are flat. The apexes of the top surfaces of the black keys (110) are approximately 1.5 cm to 2 cm above the top surfaces of the white keys (115) at the outer circumference (101) of the keyboard (100). The black keys (110) being larger than the white keys (115) and elevated relative to the white keys (115) makes the black keys (110) easier to strike and facilitates play of pentatonic scales by young children. Furthermore, the enlarged elevated black keys (110) of the keyboard (100) of FIG. 1B allows very young children to strike the black keys (110) with their palms, i.e., the black keys (110) may be played in a fashion with large arm movements like a hand drum.

If the keyboard (100) is oriented such that the c #and d #keys (110.1) and (110.2) are closest to the child, the child may possibly focus on play of just those two notes. If the keyboard (100) is oriented such that the f #, g #and a #keys (110.1), (110.2) and (110.3) are closest to the child, the child may possibly focus on play of just those three notes. If two young children each have the circular keyboard (100) of the present invention, and keyboard (100) of the first child is oriented such that the c #and d #keys (110.1) and (110.2) are closest to the first child and those are the notes predominantly played by the first child, and the keyboard (100) of the second child is oriented such that f #, g #and a #(110.1), (110.2) and (110.3) keys are closest to the second child and those are the notes predominantly played by the first child, the children can play together and “jam” in a pentatonic scale.

The keyboard (100) includes a speaker (120) located at its center. In the embodiment shown in FIG. 1B, the top surfaces of the black keys (110) and the top surfaces of the white keys (115) are flush with the height of the speaker (120) at the outer perimeter (121) of the speaker (120). However, in an alternate embodiment the top surfaces of the white keys (115) are elevated relative to the height of the speaker (120) at its outer perimeter (121) by roughly 1 cm, while the black keys (110) are flush with the height of the speaker (120) at its outer perimeter (121). This allows a player to more easily play notes within scales utilizing the white keys (115) by pressing near the speaker (120) on the white keys (115).

An important feature of the circular keyboard (100) of the present invention is that play of consecutive neighboring keys in counter-clockwise order is perceived as playing notes in order of increasing pitch, and play of consecutive neighboring keys in clockwise order is perceived as playing notes in order of decreasing pitch regardless of how many consecutive notes are played or where on the keyboard (100) the sequence of key presses is initiated or ended. According to the lexicography of the present specification, a tone generated by the circular keyboard (100) of the present invention which has an identifiable pitch of, for instance, d but is of indeterminate octave is said to have “ring pitch D”. In the following text and formulas, ring pitches are notated with capital letters, and standard octave-determinate pitches are notated in the standard notation of the letter of the pitch followed by the number of the piano octave. While the pitches of the tones produced by key depressions of the circular keyboard (100) are referred to above with simply their letter identifiers (e.g., c, c #, d, d #, etc.) above, more accurately the circular keyboard (100) of the present invention produces ring pitches (e.g., C, C #, D, D #, etc.). Algebraically, according to the present invention for instance for ring pitch D:

Φ_{D}(t)=E(ω_{d1})φ_{d1}(t)+E(ω_{d2})φ_{d2}(t)+. . . +E(ω_{d8})φ_{d8}(t), (1)

where Φ_{D}(t) is the ring pitch waveform Φ as a function of time t for a tone of ring pitch D, φ_{d1}(t) is an audio waveform φ as a function of time t of an instrument which has its fundamental at the lowest pitched d of the piano keyboard (i.e., d1), φ_{d2}(t) is the audio waveform φ of the instrument tone which has its fundamental at the next to lowest pitched d of the piano keyboard (i.e., d2), etc., ω_{d1} is the fundamental frequency of the lowest pitched d of the piano keyboard, ω_{d2} is the fundamental frequency of the next-to-lowest pitched d of the piano keyboard, etc., n is an integer, and E(ω) is a ring pitch envelope function which is a function of frequency ω and has a central peak and decreases in magnitude for small and large frequencies. The component waveforms φ of an instrument may be simple sinusoids or more complex waveforms, such as those of actual physical instruments. More generally, the ring pitch waveform Φ for ring pitch Π, where Π may be C, C #, D, D #, E, F, F #, G, G #, A, A #or B, and π would correspondingly be c, c #, d, d #, e, f, f #, g #, a, a #or b, respectively, is

Φ_{Π}(t)=E(ω_{π1})φ_{π1}(t)+E(ω_{π2})φ_{π2}(t)+. . . +E(ω_{π8})φ_{π8}(t). (2)

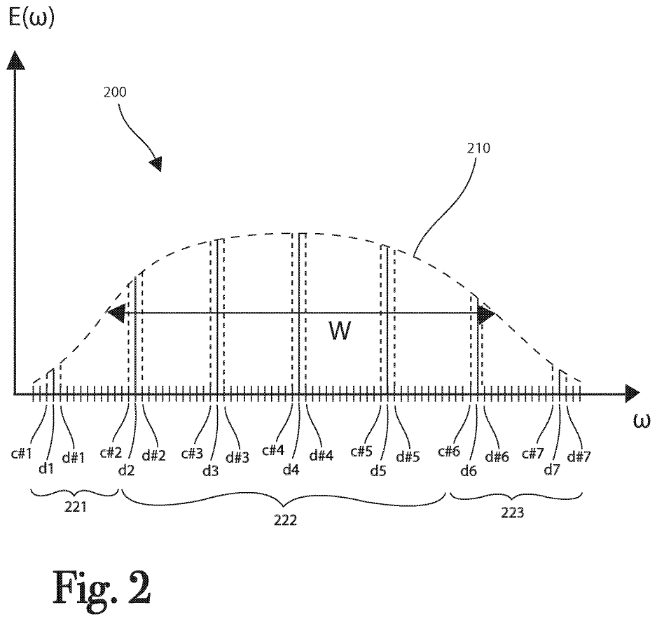

FIG. 2 shows an exemplary ring pitch envelope E(ω) (210). The horizontal axis is frequency ω on a logarithmic scale with the distance between pairs of adjacent ticks on the frequency axis corresponds to a half step of the Western twelve-tone scale. According to the present invention the ring pitch envelope E(ω) rises with increasing frequency in a low frequency range (221), is relatively flat over a central frequency region (222) which spans multiple octaves, and decreases with increasing frequency in a high frequency range (223). According to the present invention, width W at half maximum spans at least two octaves, more preferably spans at least three octaves, still more preferably spans at least four octaves, and still more preferably spans at least five octaves. Although the ring pitch envelope E(ω) (210) is depicted in FIG. 2 as falling to zero at the lefthand end of the ticks on the horizontal axis, more generally it (210) may fall to zero at its low frequency end at a higher frequency.

FIG. 2 illustrates the situation for ring pitch D, and its neighboring ring pitches C #and D #. Solid lines mark pitch d at each octave, and dashed lines mark pitches c #and d #at each octave. Due to the ring pitch envelope E(ω) having a broad central peak with a width W at half maximum of about five octaves, there are multiple instrument waveforms φ within those octaves which have ring pitch envelope E(ω) as a multiplier according to equation (1) such that they are audible when hearing the waveform of Φ_{D}(t). Notably, the instrument waveforms φ from various octaves within the width W of the peak of the ring pitch envelope E(ω) have roughly the same values of ring pitch envelope E(ω) as a multiplier according to equation (2) for ring pitches C #and D #, so the instrument waveforms φ for each octave are audible in roughly the same proportions for the audio waveform Φ_{D}(t) as for audio waveforms Φ_{C#}(t) and Φ_{D#}(t). This is why the sequence of tones when the c #, d and d #keys (110.1), (115.2) and (110.2) are depressed in sequence are perceived to be ascending in pitch while being octave indeterminate. This same effect is achieved regardless of where the starting point of a sequence of half-step keys depressions is initiated. This produces the audio equivalent of the continually ascending/descending Escher staircase.

According to one preferred embodiment of the present invention, the user may select from at least three types of instruments for the component waveforms φ. The first type of instrument has a tone with little to no attack, a sustain tone with limited overtones, and its sustain continues as long as the key is depressed, i.e., something like a tin whistle sound. The second type of instrument has a tone with attack, a sustain tone which is “buzzy,” and the sustain that continues as long as the key is depressed, i.e., something like a trumpet sound. And the third type of instrument has a tone with attack, a sustain tone which is mildly “buzzy,” and a short sustain, i.e., something like a marimba sound.

The circular keyboard (100) of the present invention includes a key transposition dial on the bottom surface (not shown) which allows for transposition by half steps, i.e.,

Π′=Π+Z (3)

where Z is the number of half steps in the transposition, Π is the ring pitch of a key (110)/(115) before transposing, Π′ is the ring pitch of a key subsequent to transposing, and addition is mod 12. Therefore, for instance, the key of the major pentatonic scale which corresponds to the black keys (110) beginning at the f #(110.3) could be transposed to correspond to the tonic of a recording based on a major scale so that a user could easily jam along with the recording by playing the black keys (110). Or the key of the minor pentatonic scale which corresponds to the black keys (110) beginning at the d #(110.1) could be transposed to correspond to the tonic of a recording based on a minor scale so that the user could easily jam along with a recording. For instance, Let it Be by The Beatles is in C major so a user could play along to this song by hitting the black keys (110) using the circular keyboard (100) by setting the key transposition dial to Z=6 in order to transpose up by six half steps so depression of the f #key (110.3) produces ring pitch C, depression of the g #key (110.4) produces ring pitch D, depression of the a #key (110.5) produces ring pitch E, depression of the c #key (110.4) produces ring pitch G, and depression of the d #key (110.5) produces ring pitch A.

According to a preferred embodiment of the present invention, the keys (110) and (115) are velocity dependent with the velocity dependance affecting the character of the tones but not the volume, or only minimally affecting the volume. According to one embodiment, when a key (110) or (115) is struck lightly or slowly the tone has minimal or no percussive transients, and when a key (110) or (115) is struck more rapidly or with greater force, the tone has more percussive transients, but the sustain portions of the tones are the same.

According to another embodiment, when a key (110) or (115) is struck lightly or slowly the tone has minimal or no percussive transients and the sustain portion of the tone has few overtones besides the octave harmonics necessary to make the tone octave indeterminate. But when a key (110) or (115) is struck more rapidly or with greater force, the tone has more percussive transients and the sustain portion has more overtones. This velocity dependence allows instrument and/or player differentiation during simultaneous play by multiple players, such differentiation being particularly advantageous for the circular keyboard (100) of the present invention because of its limited number of keys.

According to another preferred embodiment of the present invention, the keys (110)/(115) of the keyboard are translucent, and under each key (110)/(115) is one or more LED lights (not shown) with the LED lights are powered by a frequency filtering system connected to a microphone. The filtering system has twelve channels with filtering to determine signal power of the ambient sound at the ring pitch corresponding to the key (110)/(115). For instance, the filtering channel for the a key (115.6) determines the sum of the power of the ambient sound at 55 Hz, 110 Hz, 220 Hz, 440 Hz, 880 Hz, etc., and powers the LED under the a key (115.6) so that its brightness is proportional to the power of the filtered signal. Thus, the lit keys (110)/(115) indicate the current chord of the music being monitored. This allows players to see which notes might sound pleasing at any instant, thereby facilitating playing along with ambient music.

The foregoing descriptions of specific embodiments of the present invention have been presented for purposes of illustration and description. They are not intended to be exhaustive or to limit the invention to the precise forms disclosed and it should be understood that many modifications and variations are possible in light of the above teaching. The embodiments were chosen and described in order to best explain the principles of the invention and its practical application, to thereby enable those skilled in the art to best utilize the invention and various embodiments with various modifications as are suited to the particular use contemplated. For instance, play of the next note clockwise of any particular note may be perceived as descending in pitch, and play of the next note clockwise of any particular note may be perceived as ascending in pitch; the black keys and white keys may be of different sizes than what is described; although referred to as the “black” and “white” keys, the black keys may be a color other than black and the white keys may be a color other than white; the keys may not be velocity sensitive or may have velocity sensitivity different from what is described; the LEDs under each key may be multi-colored and may reflect other characteristics of the sound at that frequency; the black keys need not be larger than the white keys; etc. Accordingly, it is intended that the scope of the invention be determined not by the embodiments illustrated or the physical analyses motivating the illustrated embodiments, but rather by the appended Claims and their legal equivalents.

What is claimed is:

1. A musical instrument comprising a keyboard of keys arranged in a circle, the cardinality of said keys being twelve, said keys being of two sizes, wide keys and narrow keys, said keys being in a sequence of
a first narrow key being adjacent a first wide key,
said first wide key being adjacent a second narrow key,
said second narrow key being adjacent a second wide key, said second wide key being adjacent being adjacent a third narrow key, said third narrow key being adjacent a fourth narrow key, said fourth narrow key being adjacent a third wide key, said third wide key being adjacent a fifth narrow key, said fifth narrow key being adjacent a fourth wide key, said fourth wide key being adjacent a sixth narrow key, said sixth narrow key being adjacent a fifth wide key, said fifth wide key being adjacent a seventh narrow key, and said seventh narrow key being adjacent said first narrow key, where depression of said first narrow key generates a first tone having ring pitch C, depression of said first wide key generates a second tone having ring pitch C #,
depression of said second narrow key generates a third tone having ring pitch D,
depression of said second wide key generates a fourth tone having ring pitch D #,
depression of said third narrow key generates a fifth tone having ring pitch E,
depression of said fourth narrow key generates a sixth tone having ring pitch F,
depression of said third wide key generates a seventh tone having ring pitch F #,
depression of said fifth narrow key generates a eight tone having ring pitch G,
depression of said fourth wide key generates a ninth tone having ring pitch G #,
depression of said sixth narrow key generates a tenth tone having ring pitch A, depression of said fifth wide key generates an eleventh tone having ring pitch A #, and depression of said seventh narrow key generates a twelfth tone having ring pitch B.

2. The musical instrument of claim 1 wherein ring pitch Π has an audio waveform Φ_{Π}(t) as a function of time t given by Φ_{Π}(t)=E(ω_{π1})φ_{π1}(t)+E(ω_{π2})φ_{π2} (t)+. . . +E(ω_{π8})φ_{π8}(t), where Π can have value C, C #, D, D #, E, F, F #, G, G #, A, A #or B, and correspondingly π has value c, c #, d, d #, e, f, f #, g, g #, a, a #or b, respectively, φ_{π1}(t) is an audio waveform φ of an instrument as a function of time t which has its fundamental at the lowest pitched π of the piano keyboard, φ_{πi}(t) is an audio waveform φ of said instrument which has its fundamental at the (i-1)^{th}-from-lowest pitched π of the piano keyboard for i>1, ω_{π1} is the fundamental frequency of the lowest pitched π of the piano keyboard, ω_{πi} is the fundamental frequency of the (i-1)^{th}-from-lowest pitched π of the piano keyboard for i >1, and E(ω) is a ring pitch envelope function which is a function of frequency ω and has a central peak and decreases in magnitude for small and large frequencies.

3. The musical instrument of claim 2 wherein said central peak of said ring pitch envelope function E(ω) has a width W at half maximum of at least two octaves.

4. The musical instrument of claim 2 wherein said central peak of said ring pitch envelope function E(ω) has a width W at half maximum of at least three octaves.

5. The musical instrument of claim 2 wherein said central peak of said ring pitch envelope function E(ω) has a width W at half maximum of at least four octaves.

6. The musical instrument of claim 2 wherein said first, second, third, fourth and fifth wide keys have top surfaces which are raised relative to top surfaces of said first, second, third, fourth, fifth, sixth, and seventh narrow keys.

7. The musical instrument of claim 2 further including a key transposition dial to provide transposition by Z half steps, such that said first tone is transposed to have ring pitch (C+Z), said second tone is transposed to have ring pitch ring pitch (C #+Z), said third tone is transposed to have ring pitch (D+Z), said fourth tone is transposed to have ring pitch (D #+Z), said fifth tone is transposed to have ring pitch (E+Z), said sixth tone is transposed to have ring pitch (F+Z), said seventh tone is transposed to have ring pitch (F #+Z), said eighth tone is transposed to have ring pitch (G+Z), said ninth tone is transposed to have ring pitch (G #+Z), said tenth tone is transposed to have ring pitch (A+Z), said eleventh tone is transposed to have ring pitch (A #+Z), and said twelfth tone is transposed to have ring pitch (B+Z), where addition is mod 12.

8. The musical instrument of claim 2 further including a microphone to monitor ambient sound, a frequency filtering system having twelve channels, each of said twelve channels determining a current level of ambient sound at a ring pitch corresponding to one of said keys, and light generators to illuminate each of said keys, the illumination of a particular one of said keys corresponding to said current level of said ambient sound at said ring pitch corresponding to said particular one of said keys.

9. The musical instrument of claim 2 wherein each of said wide keys has a plan-view area that is 2/17^{ths}±15% of a plan-view area of said keyboard, and each of said narrow keys has a plan-view area that is 1/17^{th}±15% of said plan-view area of said keyboard.

10. The musical instrument of claim 2 wherein each of said wide keys has a plan-view area that is 2/17^{ths}±10% of a plan-view area of said keyboard, and each of said narrow keys has a plan-view area that is 1/17^{th}±10% of said plan-view area of said keyboard.

11. The musical instrument of claim 2 wherein each of said wide keys and said narrow keys has a plan-view area that is 1/12^{th}±10% of a plan-view area of said keyboard.
